(19) United States
(12) Patent Application Publication
(10) Pub. No.: US 2026/0064075 A1
(43) Pub. Date: Mar. 5, 2026

(54) FIXATION DEVICE AND IMAGE FORMATION APPARATUS

(71) Applicant: Oki Electric Industry Co., Ltd., Tokyo (JP)

(72) Inventor: Kenta KAMIDE, Tokyo (JP)

(73) Assignee: Oki Electric Industry Co., Ltd., Tokyo (JP)

(21) Appl. No.: 19/263,482

(22) Filed: Jul. 9, 2025

(30) Foreign Application Priority Data
Sep. 4, 2024 (JP) 2024-152688

(51) Int. Cl. G03G 21/16; G03G 15/20

(52) U.S. Cl. CPC G03G 21/1685; G03G 15/2025; G03G 15/2064; G03G 2215/2025; G03G 2221/1639

(57) ABSTRACT

A fixation device according to an embodiment includes: a belt member extending in a first direction; a cleaning member extending in the first direction and in contact with the belt member to clean the belt member; an opposing member extending in the first direction, and opposed to the cleaning member in a second direction across the belt member, to form a nip portion with the cleaning member; and a support member supporting the opposing member. The opposing member is configured, when the opposing member and the support member are removed from the fixation device, to be supported by the support member such that the opposing member is restricted from moving in the first direction and is movable in the second direction relative to the support member.

### CROSS REFERENCE TO RELATED APPLICATIONS

This application claims priority based on 35 USC 119 from prior Japanese Patent Application No. 2024-152688 filed on Sep. 4, 2024 entitled “FIXATION DEVICE AND IMAGE FORMATION APPARATUS,” the entire contents of which are incorporated herein by reference.

### BACKGROUND

The disclosure may relate to a fixation device and an image formation apparatus such as an image formation apparatus that is suitably applied to an electrophotographic printer.

In a related art, an image formation apparatus (may be referred to a printer) is widely spread, which performs printing processing, by forming a toner image using toner (also called developer) by image formation unit based on image data supplied from a computer or other device, transferring the developer image to a medium such as paper, and then applying by a fixation device heat and pressure to the developer image to fix the image to the medium. The fixation device may employ a sheet or plate-shaped heater, along with a belt member serving as a fixation member, to enable quick start and energy saving, for example. In the art, a fixation device provided with a cleaning member is also known (see, for example, Patent Document 1).

Patent Document 1: Japanese Utility Model Application Publication No. H2-51369

### SUMMARY

In such a fixation device, it may be preferable to thoroughly clean the fixation member in the longitudinal direction thereof.

An object of one or more embodiments of the disclosure may be to provide a fixation device and an image formation apparatus that are capable of sufficiently cleaning the fixation member in the longitudinal direction.

A fist aspect of an embodiment may be a fixation device that may include: a belt member extending in a first direction; a cleaning member extending in the first direction and being in contact with the belt member to clean the belt member; an opposing member extending in the first direction, and opposed to the cleaning member in a second direction across the belt member, to form a nip portion with the cleaning member; and a support member supporting the opposing member, wherein the opposing member is configured, when the opposing member and the support member are removed from the fixation device, to be supported by the support member such that the opposing member is restricted from moving in the first direction and is movable in the second direction relative to the support member.

A second aspect of an embodiment may be an image formation apparatus including the fixation device according to the first aspect.

According to the aspects described above, the longitudinal position of the opposing member is fixed relative to the support member while the opposing member remains movable relative to the support member in directions other than the longitudinal direction. Therefore, even if a difference in thermal expansion coefficient arises between the opposing member and the support member, the occurrence of singularities in the longitudinal pressure distribution in the nip portion can be prevented.

According to the aspect described above, it is possible to realize a fixation device and an image formation apparatus that can thoroughly clean the fixation member in the longitudinal direction.

### BRIEF DESCRIPTION OF DRAWINGS

FIG. 1 is a left side view illustrating a configuration of an image formation apparatus;

FIG. 2 is a perspective view illustrating a configuration (1) of a fixation device; FIG. 3 is a cross-sectional view taken along the line A-A in FIG. 2, illustrating a configuration (1) of the fixation device according to a first embodiment;

FIG. 4 is a partial cross-sectional view taken along the line B-B in FIG. 2, illustrating a configuration (2) of the fixation device according to a first embodiment;

FIG. 5 is a plan view illustrating a configuration (1) of an opposing member and a fixation frame according to a first embodiment.

FIG. 6 is a cross-sectional view taken along the line A-A in FIG. 5, illustrating a configuration (2) of the opposing member and the fixation frame according to a first embodiment;

FIG. 7 is an enlarged view of the region A illustrated in FIG. 3, illustrating only a cleaning roller, the opposing member, and the fixation frame;

FIG. 8 is a schematic diagram illustrating a configuration of the opposing member according to a first embodiment;

FIG. 9 is a plan view illustrating a configuration (3) of the fixation device according to a first embodiment;

FIG. 10 is an enlarged view illustrating the region A illustrated in FIG. 3, illustrating only a flange, the opposing member, and the fixation frame;

FIG. 11 is a rear view illustrating crown shapes of a refreshing roller, the cleaning roller, the opposing member, and the fixation frame;

FIG. 12 is a cross-sectional view illustrating measurement of a crown amount of the opposing member;

FIG. 13 is a plan view illustrating a configuration (1) of an opposing member, a fixation frame, and a shoulder screw according to a second embodiment;

FIG. 14 is a cross-sectional view taken along the line A-A in FIG. 13, illustrating a configuration (2) of the opposing member, the fixation frame, and the shoulder screw according to a second embodiment; and

FIG. 15 is a cross-sectional view taken along the line B-B in FIG. 13, illustrating a configuration (3) of the opposing member, the fixation frame, and the shoulder screw according to a second embodiment.

### DETAILED DESCRIPTION

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

### 1. First Embodiment

### 1-1. Configuration of Image Formation Apparatus

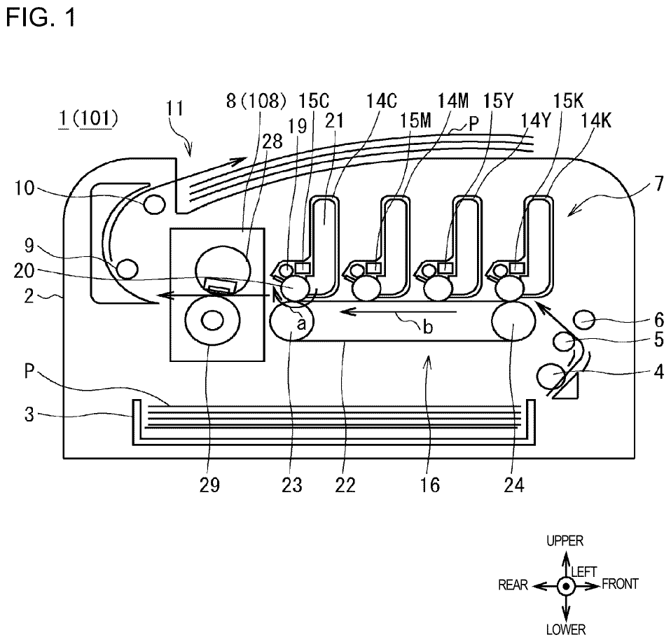

As illustrated in FIG. 1, the image formation apparatus 1 is, for example, a printer using an electrophotographic method, and forms a black-and-white image or a color image on a print medium P such as paper by performing an image forming operation using a developer such as toner. In the following description, from any point along the conveyance path along which the print medium P is conveyed, a position closer to or a direction toward a medium feed cassette 3 is referred to as “upstream.” Further, from any point along the conveyance path of the print medium P, a position closer to or a direction toward the stacker 11, where the discharged print media P are to be stacked, is referred to as “downstream. ” Furthermore, the direction from upstream to downstream is referred to as a conveyance direction. In the following description, the rightmost side in FIG. 1 is the front of the image formation apparatus 1, and the vertical, horizontal, and front-rear directions are defined based on a viewpoint facing the front. The image formation apparatus 1 is of a so-called direct transfer type. That is, the image formation apparatus 1 is configured to directly transfer toner images as developer images from photosensitive drums 20 (described later) of image formation units 14 (described later) to a print medium P.

The image formation apparatus 1 controls the overall operation of the image formation apparatus using a print controller (not illustrated). The print controller includes a CPU (Central Processing Unit), ROM (Read Only Memory), RAM (Random Access Memory) and the like, which are not illustrated in the figure, and executes various processes by reading and executing predetermined programs. The image formation apparatus 1 also includes, in a box-shaped housing 2, a medium feed cassette 3, a hopping roller 4, a registration roller 5, a conveyance roller 6, an image formation section 7, a fixation device 8, and discharge rollers 9 and 10.

The medium feed cassette 3 is disposed in a lower part of the housing 2 and accommodates a plurality of print media P in a stacked manner. The hopping roller 4 is provided downstream of the medium feed cassette 3. The hopping roller 4 rotates while being in pressure contact with the surface of the print medium P, thereby feeding the print medium P downstream along the conveyance path.

The registration roller 5 is provided downstream of the hopping roller 4. The registration roller 5 conveys the print medium P toward the conveyance roller 6. When the print medium P is conveyed, the leading edge of the print medium P abuts against the registration roller 5, thereby correcting any skew of the print medium P. A conveyance roller 6 is provided downstream of the registration rollers 5. The conveyance roller 6 conveys the print medium P toward the image formation section 7 provided downstream of the conveyance roller 6. The image formation section 7 transfers a toner image onto the print medium P, and conveys the print medium 7 to the fixation device 8.

The fixation device 8 applies heat and pressure to the toner image transferred onto the print medium P conveyed from the transfer belt unit 16 of the image formation section 7, thereby fixing the toner image onto the print medium P, and conveys the print medium P along the conveyance path toward the discharge roller 9.

The discharge roller 9 is provided downstream of the fixation device 8. The discharge roller 9 conveys the print medium P toward the discharge roller 10 provided downstream of the discharge roller 9. The discharge roller 10 conveys the print medium P toward the stacker 11. As a result, the image formation apparatus 1 discharges the print medium P on which the toner image has been fixed onto the stacker 11 provided on the outside of the housing 2.

### 1-2. Configuration of Image Formation Unit

The image formation section 7 is a mechanism configured to form an image (toner image) and transfer the image onto the print medium P. The image formation section 7 includes four image formation units 14 (image formation units 14K, 14Y, 14M and 14C), four LED heads 15 (LED heads 15K, 15Y, 15M and 15C), and a transfer belt unit 16. The image formation units 14K, 14Y, 14M, and 14C are arranged in this order along the conveyance direction of the print medium P. Hereinafter, the image formation units 14K, 14Y, 14M and 14C may be referred to as image formation units 14, and the LED heads 15K, 15Y, 15M and 15C may be referred to as LED heads 15.

The image formation unit 14 forms an image using toner as a developer, based on print data transmitted from an external apparatus such as a personal computer. The image formation units 14K, 14Y, 14M and 14C form black, yellow, magenta and cyan images, respectively. The image formation units 14K, 14Y, 14M and 14C have the same configuration, except for the color of the toner used. Each of the image formation units 14 mainly includes a charging roller 19, a photosensitive drum 20, and a toner cartridge 21.

The photosensitive drum 20 is a cylindrical member that is configured carry an electrostatic latent image on the surface (surface layer) thereof, and is formed of a photosensitive material, such as an organic photosensitive material. The photosensitive drum 20 rotates in a direction “a”, which is a clockwise direction in FIG. 1, by power transmitted from a motor (not illustrated). The photosensitive drum 20 is charged by the charging roller 19 and exposed to light by the corresponding LED head 15. As a result, an electrostatic latent image is formed on the surface of the photosensitive drum 20. Then, the toner is supplied from a development roller (not illustrated) onto the photosensitive drum, so that a toner image corresponding to the electrostatic latent image is formed (developed) on the photosensitive drum 20.

The toner cartridge 21 is configured to contain therein toner. Specifically, the toner cartridges 21 of the image formation units 14K, 14Y, 14M and 14C contain black, yellow, magenta and cyan toner, respectively.

The LED heads 15 (LED heads 15K, 15Y, 15M and 15C) are mechanisms that irradiate light onto the photosensitive drums 20 of the image formation units 14K, 14Y, 14M and 14C, respectively, and are configured with LEDs (Light Emitting Diodes).

The transfer belt unit 16 is a mechanism that transfers the toner image formed on the surface of the photosensitive drum 20 onto the surface of the print medium P by Coulomb force, and conveys the print medium P in the direction b, which is the conveyance direction. The transfer belt unit 16 conveys the print medium P onto which the image has been transferred toward the fixation device 8. The transfer belt unit 16 includes a transfer belt 22, a drive roller 23, a driven roller 24, and four transfer rollers (not illustrated).

The transfer belt 22 is an endless circular belt capable of carrying the print medium P thereon. The transfer belt 22 is wound around and stretched between the drive roller 23 and the driven roller 24. The drive roller 23 is a rotation member that rotates by power transmitted from a motor (not illustrated) to convey the print medium P toward the fixation device 8, and causes the transfer belt 22 to rotate in a circular motion. The driven roller 24 is a member that supports the transfer belt 22 together with the drive roller 23 and adjusts the tension applied to the transfer belt 22.

The transfer roller (not illustrated) is a rotation member that transfers a toner image formed on the surface of the photosensitive drum 20 of the corresponding image formation unit 14 onto the transfer surface of the print medium P. The transfer rollers are respectively disposed opposite the photosensitive drums 20 of the image formation units 14K, 14Y, 14M and 14C with the transfer belt 22 interposed therebetween. A predetermined transfer voltage is applied to each of the transfer rollers, whereby the toner images formed on the photosensitive drums 20 by the image formation units 14 is transferred onto the transfer surface of the print medium P.

### 1-3. Configuration of Fixation Device

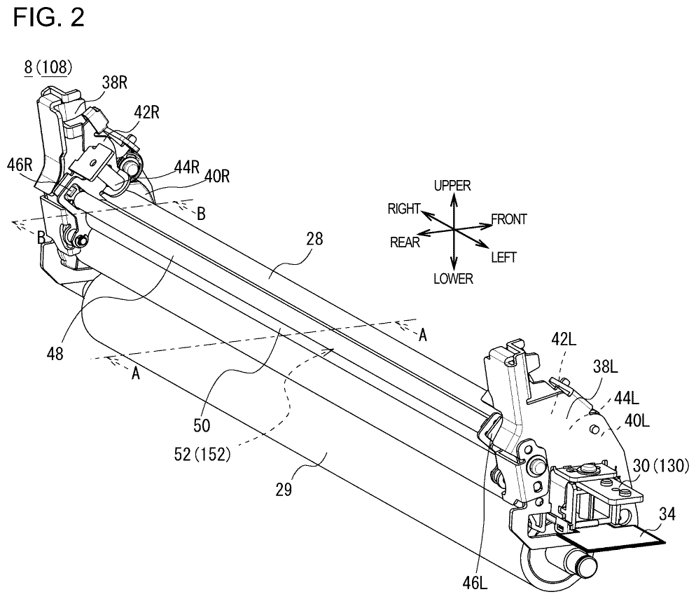

As illustrated in FIGS. 2 and 3, the fixation device 8 generally includes a fixation belt 28 arranged above the conveyance path of the print medium P, and a pressure roller 29 arranged below the conveyance path. In addition to the fixation belt 28 and the pressure roller 29, the fixation device 8 includes main levers 38 (main levers 38L and 38R), flanges 40 (flanges 40L and 40R), sub-levers 42 (sub-lever 42L and 42R), springs 44 (springs 44L and 44R), bearings 46 (bearings 46L and 46R), a refreshing roller 48, and a cleaning roller 50.

Incidentally, the fixation device 8 is generally surrounded by a housing thereof (not illustrated). This housing is appropriately provided with holes and the like to allow the print medium P to passe along the conveyance path. As illustrated in FIG. 1, the fixation device 8 is disposed such that the center axis of the fixation belt 28 is positioned on the front side of the center axis of the pressure roller 29. However, for convenience of explanation, the following description will be made assuming the center axis of the fixation belt 28 and the center axis of the pressure roller 29 are located at the same position in the front-rear direction.

### 1-3-1. Configuration of Fixation Belt

The fixation belt 28 is an endless belt made of a cylindrical film made of a material that is both flexible and heat resistant, and has a substantially cylindrical shape with the center axis thereof extending in the left-right direction. The fixation belt 28 has a multi-layer structure including a base material, an elastic layer, and a surface layer stacked in that order. The base material is made of a heat-resistant resin such as PI (polyimide) or a metal such as SUS (stainless steel). The elastic layer is made of silicone rubber. The surface layer is made of a fluororesin coating such as PFA (perfluoroalkoxyalkane) or a tube processed from such a fluororesin coating. In addition, the inner circumferential surface of the fixation belt 28 is coated with sliding grease whose main component is PFPE (perfluoropolyether). The fixation belt 28 has the shape maintained at both left and right end portions by flanges 40L and 40R. Within the interior space of the fixation belt 28, a fixation frame 30, a heater holding member (or a heater holder) 32, a sheet heater 34, a heat diffusion member 36, and an opposing member 52 are provided. The fixation belt 28 rotates with the rotation of the pressure roller 29 and transmits heat from the sheet heater 34 to the print medium P.

### 1-3-2. Configuration of Fixation frame

As illustrated in FIGS. 2, 3 and 7, the fixation frame 30 extends in the longitudinal direction (the left-right direction), and the cross section of the fixation frame 30, as viewed from the left side, has a shape like an upper case letter “U” rotated 180 degrees. The fixation frame 30, and holds the opposing member 52. That is, the fixation frame 30 includes a recessed portion located opposite to the heater holding member 32. The fixation frame 30 is made of metal, such as a galvanized steel plate, and both left and right end portions thereof are fixed to main levers 38L and 38R. The fixation frame 30 is biased toward the pressure roller 29 via the main levers 38L and 38R by a bias or pressure member(s) (not illustrated).

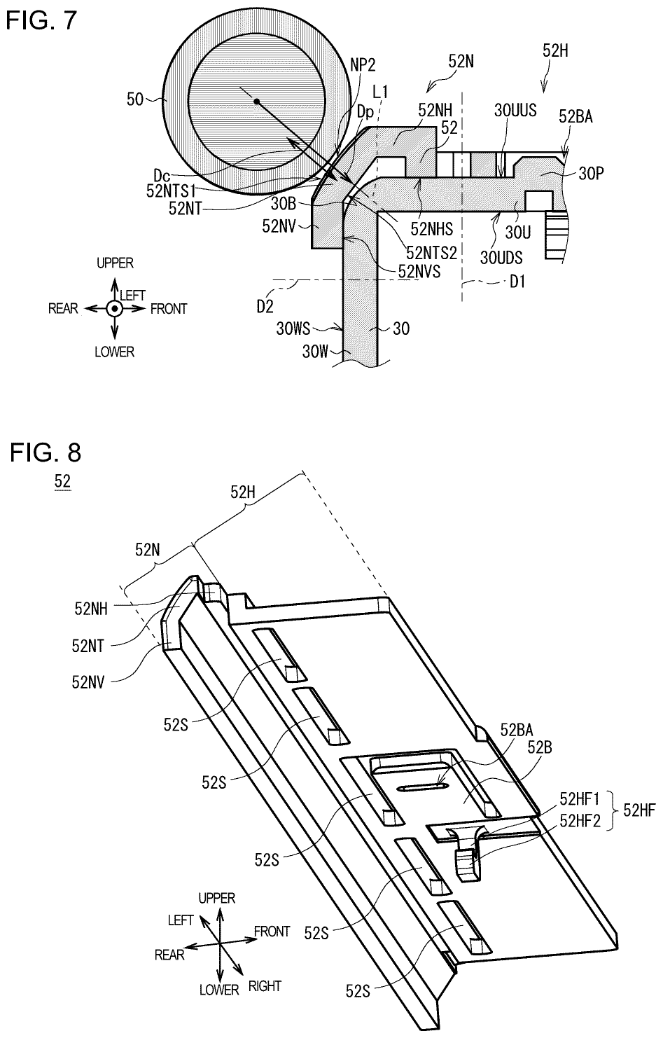

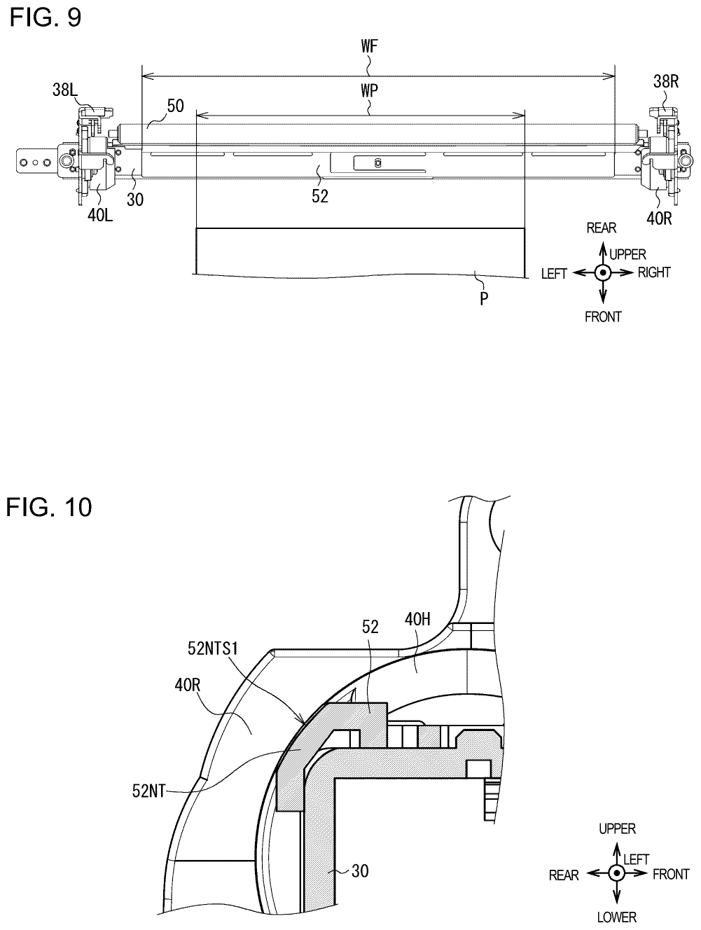

The fixation frame 30 is roughly divided into an upper plate 30U and wall plates 30W (which may be referred to as side plates or upright plates), and includes an opening that is opened toward the lower side of the fixation frame 30. The upper plate 30U of the fixation frame is a plate-like member that extends in the longitudinal direction thereof, which is the left-right direction, and is thin in the vertical direction with a constant thickness. A fixation frame upper surface 30UUS, which is an upper surface of the fixation frame upper plate 30U, and a fixation frame lower surface 30UDS, which is a lower surface of the fixation frame upper plate 30U, are flat. A flat portion width WF, which is the width in the longitudinal direction (left-right direction) of the upper surface 30UUS of the upper plate and outer surfaces 30WS of fixation frame wall plates (described later), is wider than the paper width WP, which is the width in the left-right direction of borderless printing supported by the image formation apparatus 1, as illustrated in FIG. 9. Hereinafter, the direction perpendicular to the upper plate 30U of the fixation frame may be referred to as an upper plate perpendicular direction D1 (FIG. 7).

The wall plates 30W extend downward from both front and rear edges of the upper plate 30U in a direction perpendicular to the upper plate 30U (only the rear wall plate 30W is illustrated in FIG. 7). Each of the wall plates 30W is a plate-like member that is elongated in the left-right direction and thin in the front-rear direction with a constant thickness. The wall plate outer surface 30WS, which is the rear side of the rear wall plate 3, is flat. The wall plate outer surface 30WS, which is the front side of the front wall plate 30W (not illustrated in FIG. 7), is flat. Hereinafter, the direction perpendicular to the wall plate 30W of the fixation frame is also referred to as a wall plate perpendicular direction D2. The wall plate perpendicular direction D2 is perpendicular to the upper plate perpendicular direction D1.

Bent portions 30B are formed at the connection points between the upper plate 30U and the rear and front wall plates 30W of the fixation frame. An upper rear surface of the bent portion 30B has a curved shape.

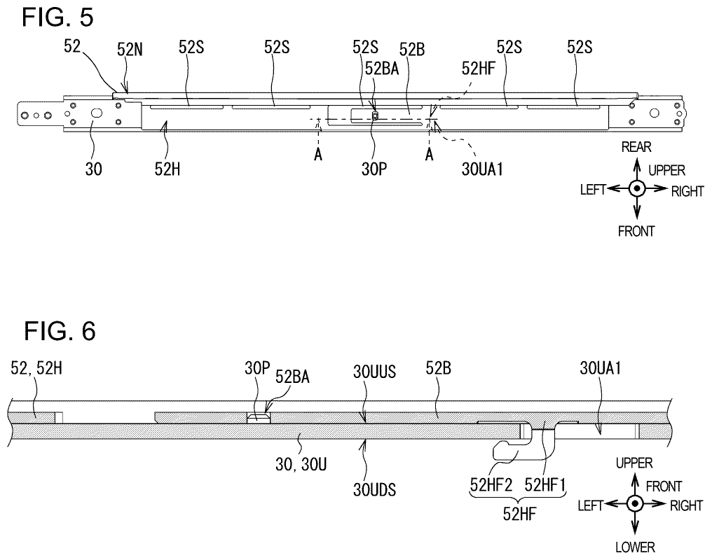

The fixation frame upper plate 30U includes an engagement hole 30UA1 (FIGS. 5 and 6) penetrating from the upper surface 30UUS to the lower surface 30UDS of the upper plate 30U at the same position as a hook portion 52HF (described later) of the opposing member 52 in the front-rear and left-right directions.

A substantially cylindrical protrusion (embossment) 30P protrudes upward from the upper surface 30UUS of the fixation frame at a location that corresponds, in the front-rear and left-right directions, to a positioning hole 52BA (described later) of the opposing member 52. The outer diameter of the protrusion 30P is approximately the same as the width in the left-right direction of the positioning hole 52BA of the opposing member 52, and is shorter than the length in the front-rear direction of the positioning hole 52BA.

### 1-3-3. Configuration of Heater Holding Member

As illustrated in FIG. 3, the heater holding member 32 is fixed to the fixation frame 30, and a portion of the heater holding member 32 is inserted in a recessed portion of the fixation frame 30 below the fixation frame 30. The heater holding member 32 is made of a heat-resistant sliding resin, and holds the heat diffusion member 36 and the sheet heater 34.

### 1-3-4. Configuration of Sheet Heater

As illustrated in FIGS. 2 and 3, the sheet heater 34 is a sheet heating element that extends in the longitudinal direction (left-right direction) and is thin in the vertical direction, with a heating pattern formed on a substrate made of stainless steel (SUS), and the heating pattern is protected from above by a glass coating. The sheet heater 34 generates the amount of heat necessary for the fixation operation under the control of a power supplier and a controller (not illustrated).

### 1-3-5. Configuration of Heat Diffusion Member

As illustrated in FIG. 3, the heat diffusion member 36 is approximately flat and extends in the left-right direction along the sheet heater 34. The heat diffusion member 36 is held by the heater holding member 32, with the upper surface thereof abutting against the lower surface of the sheet heater 34 and the lower surface thereof abutting against the inner surface of the fixation belt 28. The heat diffusion member 36 is made of a metal such as SUS (stainless steel) and is a metal plate member with high thermal conductivity. The heat diffusion member 36 has a cross section shaped like a capital letter “U,” and both front and rear end portions are bent upward in the thickness direction, i.e., the vertical direction. That is, the heat diffusion member 36 includes a recess located opposite to the sheet heater 34. The heat diffusion member 36, by virtue of the properties of the metal material, efficiently contacts and transmits heat. That is, the heat diffusion member transmits the heat generated by the sheet heater 34 to the fixation belt 28, with diffusing the heat evenly in the longitudinal direction, thereby reducing uneven heat generation.

### 1-3-6. Configuration of Pressure Roller

On the other hand, the pressure roller 29 is formed in a cylindrical shape with the center axis thereof aligned in the left-right direction, and has a multi-layer structure in which an elastic layer and a PFA tube layer are laminated over a hollow metal core. The pressure roller 29 is rotatably supported by a support member (not illustrated). For this reason, in the fixation device 8, the fixation belt 28 is pressed against the pressure roller 29, thereby forming a fixing nip portion NP1 between the fixation belt 28 and the pressure roller 29, which sandwich the print medium P conveyed from the transfer belt 22 (FIG. 1). The pressure roller 29 is rotated by a driver or driving device (not illustrated), and rotates the fixation belt 28 along with the rotation of the pressure roller 29.

### 1-3-7. Configuration of Main Ever

As illustrated in FIGS. 2 and 3, the main levers 38L and 38R are provided respectively on the left and right sides of the fixation belt 28, i.e., on the outer sides in the left-right direction. The main lever 38R is made of a metal, such as a galvanized steel plate, and is configured to be rotatable about a main lever rotation fulcrum 38F provided at the front lower end thereof. The main levers 38L and 38R are biased by pressure members (not illustrated) in a main lever pressure direction Dm, which corresponds to the counterclockwise direction in FIG. 3, about a main lever rotation fulcrum 38F. As a result, the main levers 38L and 38R bias the fixation belt 28 toward the pressure roller 29 via the fixation frame 30.

### 1-3-8. Configuration of Flange

As illustrated in FIG. 2, the flanges 40L and 40R are fastened by screws to the main levers 38L and 38R, respectively, at positions on the inner sides of the main levers 38L and 38R in the left-right direction. The flanges 40L and 40R are made of heat-resistant sliding resin and are provided on both the left and right outer sides of the fixation belt 28. Although only the flange 40R on the right side is illustrated in FIG. 10, the flanges 40L and 40R include the belt support portions 40H that protrude toward the inside in the left and right directions. The outer circumferential surface of each belt support portion 40H is abutted against the inner surface of the fixation belt 28, thereby regulating and maintaining the shape of the fixation belt 28. The outer circumferential surface of the belt support portion 40H of the flange 40R is substantially flush with the right end portion of a nip surface 52NTS1 (described later) of the opposing member 52 when viewed from the left side, and the surfaces are aligned. Since the flange 40L is configured symmetrically to the flange 40R, a description thereof will be omitted, but the outer circumferential surface of the belt support portion 40H of the flange 40L is substantially flush with the left end portion of the nip surface 52NTS1 (described later) of the opposing member 52 when viewed from the left side, and the surfaces are aligned.

### 1-3-9. Configuration of Sub-Lever

As illustrated in FIGS. 2 and 3, the sub-levers 42L and 42R are rotatably supported by the main levers 38L and 38R, respectively, on the inner side of the main levers in the left-right direction, about sub-lever rotation fulcrums 42F provided on the main levers 38L and 38R as a rotation axis. The sub-levers 42L and 42R are made of metal such as a galvanized steel plate and are biased by springs 44L and 44R, respectively, in the sub-lever pressure direction Ds, which corresponds to the clockwise direction in FIG. 3, about a sub-lever rotation fulcrum 42F. Therefore, in the fixation device 8, in a nip state in which the opposing portion 52N (described later) of the opposing member 52 is pressed by the cleaning roller 50 via the fixation belt 28, the cleaning roller 50 is pressed against the fixation belt 28 by the sub-levers 42L and 42R via the bearings 46L and 46R and the refreshing roller 48 in a cleaning roller biasing direction Dp along a cleaning roller contact/separation direction Dc illustrated in FIG. 7, and a cleaning nip portion NP2 (FIG. 3) is formed between the opposing member 52 and the cleaning roller 50. The cleaning roller contact/separation direction Dc is inclined at approximately 45 degrees with respect to the upper plate perpendicular direction D1 and the wall plate perpendicular direction D2, and is a downward-sloping direction inclined at approximately 45 degrees with respect to the wall plate perpendicular direction D2.

### 1-3-10. Configuration of Bearing

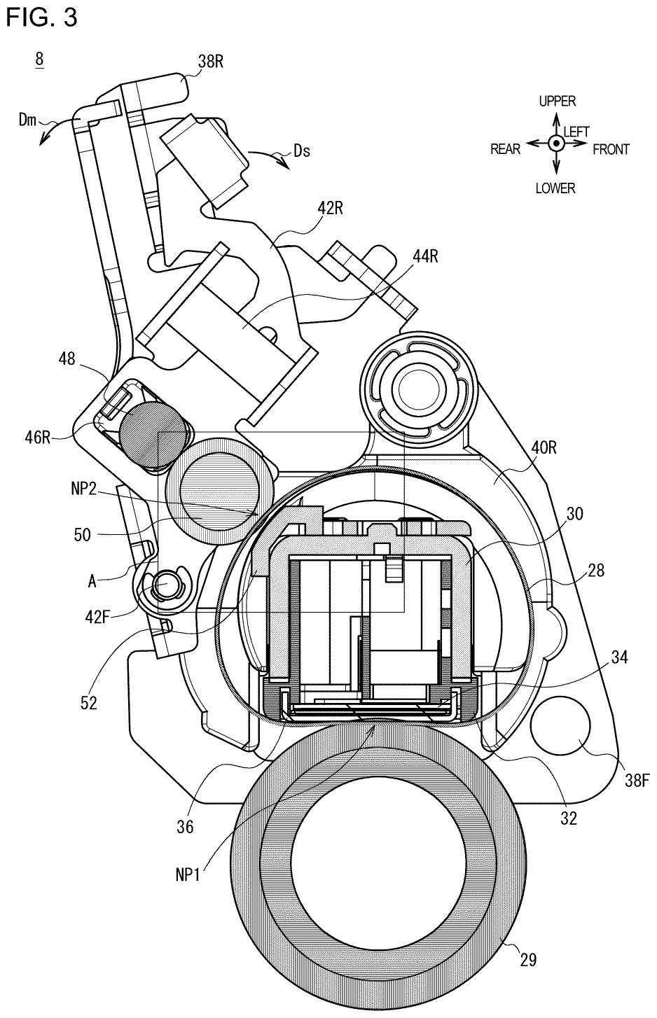

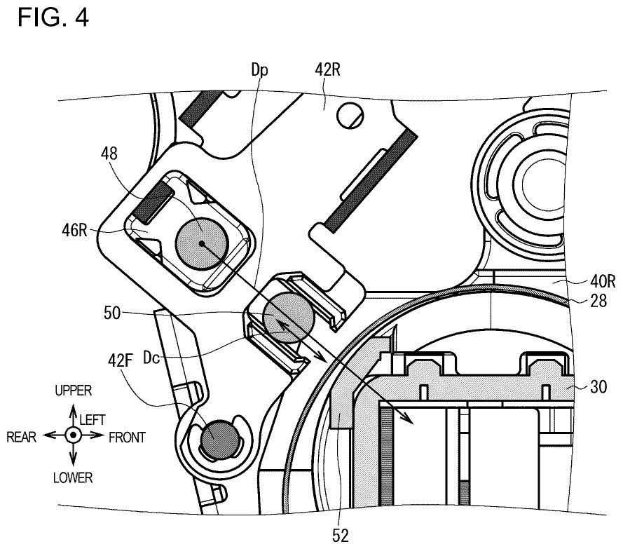

As illustrated in FIGS. 2 and 3, the bearings 46L and 46R are fixed to the sub-levers 42L and 42R, respectively. The bearings 46L and 46R are located on the rear upper side of the fixation belt 28 and rotatably support the refreshing roller 48. The bearings 46L and 46R are made of heat-resistant sliding resin. As illustrated in FIG. 4, the bearings 46L and 46R support the cleaning roller 50 so as to be movable in a contact/separation direction Dc, while restricting movement in the circumferential direction of the fixation belt 28. The bearing 46L is configured symmetrically to the bearing 46R, and therefore a description thereof will be omitted.

### 1-3-11. Configuration of the Refresh Roller

The refreshing roller 48 is formed in a cylindrical shape with the center axis thereof aligned in the left-right direction, is disposed at a rear upper position relative to the fixation belt 28. The refreshing roller 48 is solid and made of metal such as SUS (stainless steel). The refreshing roller 48 is curved as a whole so that the central portion thereof in the left-right direction bulges out, forming a crown shape with a central convexity (details will be described later). The refreshing roller 48 has fine grooves (cutting marks) formed on the circumferential surface thereof along the circumferential direction. When the refreshing roller rotates in contact with the circumferential surface of the cleaning roller 50, toner on the circumferential surface of the cleaning roller 50 adheres to the circumferential surface of the refreshing roller 48, allowing the refreshing roller 48 to collect the toner.

### 1-3-12. Configuration of Cleaning Roller

The cleaning roller 50 is formed in a cylindrical shape with the center axis thereof extending in the left-right direction. The cleaning roller 50 is disposed between the refreshing roller 48 and the fixation belt 28 and has a multi-layer structure in which an elastic layer made of silicone rubber is layered over a core metal made of a metal such as SUS (stainless steel). The cleaning roller 50 has a straight shape with a constant diameter from one end to the other end in the left-right direction. The cleaning roller 50 rotates while in contact with the outer circumferential surface of the fixation belt 28, and collects the toner attached on the fixation belt 28 by adhering it to the circumferential surface of the cleaning roller 50.

### 1-3-13. Configuration of Opposing Member and Method of Fixing Opposing Member

The opposing member 52 extends in the longitudinal direction (the left-right direction) and is disposed above the fixation frame 30 and fixed to the fixation frame 30. In an embodiment, the opposing member 52 is made of a heat-resistant sliding resin same as those of the flanges 40L and 40R, supports the load of the cleaning roller 50 from inside the fixation belt 28, and forms a cleaning nip portion NP2 (FIG. 7). As illustrated in FIGS. 5, 6, 7 and 8, the opposing member 52 includes a support portion 52H, an opposing portion 52N, and slits 52S.

### 1-3-13-1. Configuration of Fixing Portion

The support portion 52H is a plate-like member that extends in the longitudinal direction (the left-right direction) and is thin in the vertical direction. The support portion 52H includes a flexible portion 52B (or a resiliently deformable portion), a hook portion 52HF, and the positioning hole 52BA, and is supported by the fixation frame 30.

The flexible portion 52B is formed at approximately the center in the longitudinal direction of the support portion 52H. The flexible portion 52B is formed with gaps between itself and the support portion 52H on the front, rear, and left sides, and is connected to the support portion 52H only on the right side. This configuration allows the flexible portion 52B to bend (resiliently deform), enabling its left end to move up and down with its right end serving as a fulcrum. The gap that is formed on the rear side of the flexible portion 52B also functions as a slit 52S.

The positioning hole 52BA is provided at a left part of the flexible portion 52B, which corresponds to approximately the center of the support portion 52H in the left-right direction. The positioning hole 52BA is an elongate hole (long hole) that extends linearly along the short side direction (the front-rear direction) and penetrates from the upper surface to the lower surface of the support portion 52H.

The protrusion 30P of the fixation frame 30 is fitted into the positioning hole 52BA. The positioning hole 52BA has a width in the left-right direction that is substantially equal to the outer diameter of the protrusion 30P, and a length in the front-rear direction that is greater than the outer diameter of the protrusion 30P. Therefore, in the state where the protrusion 30P of the fixation frame 30 fits into the positioning hole 52BA, no gap is formed between the left end of the protrusion 30P and the left end of the positioning hole 52BA, and between the right end of the protrusion 30P and the right end of the positioning hole 52BA. On the other hand, in the state where the protrusion 30P of the fixation frame 30 fits into, for example, the center portion in the front-rear direction of the positioning hole 52BA, a gap is formed between the front end of the protrusion 30P and the front end of the positioning hole 52BA, and a gap is also formed between the rear end of the protrusion 30P and the rear end of the positioning hole 52BA. Therefore, the protrusion 30P of the fixation frame 30 is fitted into the positioning hole 52BA so as to be immovable in the left-right direction but movable in the front-rear direction. As a result, the opposing member 52 is fixed to the fixation frame 30 in a state where the opposing member 52 is positioned so as not to move in the longitudinal direction relative to the fixation frame 30 while being allowed to wobble to some extent in the shorter side direction (i.e., the front-rear direction) within the positioning hole 52BA.

The hook portion 52HF protrudes downward from the lower surface of the support portion 52H, at a position on the right side of the right end of the flexible portion 52B in the left-right direction, which corresponds to the center portion of the support portion 52H in the front-rear direction. The hook portion 52HF has a shape resembling a capital letter “L” rotated 90 degrees counterclockwise in FIG. 6. The hook portion 52HF is formed with a hole-penetrating portion 52HF1 (a projection or column) that extends downward from the lower surface of the support portion 52H, and an engagement portion 52HF2 that extends leftward at a right angle from the hole-penetrating portion 52HF1.

The opposing member 52 is fixed to the fixation frame 30 by clamping the fixation frame upper plate 30U with the hook portion 52HF in a state in which the hook portion 52HF is inserted into the engagement hole 30UA1 of the fixation frame 30, the hole-penetrating portion 52HF1 reaches below the engagement hole 30UA1 of the fixation frame 30, and the left end of the engagement portion 52HF2 reaches to the left of the engagement hole 30UA1.

The length in the vertical direction between the lower surface of the support portion 52H and the upper end of the engagement portion 52HF2 is greater than the plate thickness of the fixation frame upper plate 30U. Therefore, a certain amount of gap is provided between the fixation frame lower surface 30UDS and the upper end of the left end of the engagement portion 52HF2. For this reason, the opposing member 52 is attached to the fixation frame 30 in such a manner that the opposing member 52 can wobble to a certain extent in the vertical direction, but not to the extent that it would become detached due to impacts during transportation or when the cleaning nip portion NP2 is in a non-nip state.

In this configuration, during assembly of the fixation device 8, the opposing member 52 is moved downward from the upper side of the fixation frame 30 to insert the hook portion 52HF into the engagement hole 30UA1, and then slid leftward. With this leftward slide of the opposing member 52, the flexible portion 52B of the opposing member 52 override the protrusion 30P of the fixation frame 30, as the flexible portion 52B is bent to move the left end thereof upward with the right end thereof as a fulcrum. When the positioning hole 52BA of the flexible portion 52B reaches the protrusion 30P, the flexible portion 52B returns to its original shape such that the left end moves downward with the right end as the fulcrum, whereby the protrusion 30P fits into the positioning hole 52BA. At this time, the left end of the engagement portion 52HF2 reaches to the left of the engagement hole 30UA1, thereby fixing the opposing member 52 to the fixation frame 30.

### 1-3-13-2. Configuration of Opposing Portion

The opposing portion 52N is a plate-like member extending in the longitudinal direction (the left-right direction), and includes a horizontal plate 52NH, an inclined plate 52NT, and a vertical plate 52NV, and faces the cleaning roller 50.

The horizontal plate 52NH extends rearward, in the front-rear direction, from the upper side of the rear end of the support portion 52H to the rear end of the fixation frame upper plate 30U (i.e., the front end of the bent portion 30B). The horizontal plate 52NH includes, at its front lower end, a lower surface 52NHS that is flat and parallel to the upper surface 30UUS of the fixation frame 30. The lower surface 52NHS is in contact with the upper surface 30UUS of the fixation frame with no gap therebetween. The horizontal plate lower surface 52NHS is parallel to the wall plate perpendicular direction D2.

The inclined plate 52NT is bent at an angle of approximately 45 degrees and extends from the rear end of the horizontal plate 52NH toward the rear-downward direction, reaching the upper end of the fixation frame wall plate 30W (i.e., the lower end of the bent portion 30B). This inclined plate 52NT forms a nip surface 52NTS1 on the upper rear side thereof and forms a non-contact surface 52NTS2 on the lower front side thereof. The nip surface 52NTS1 has a curved cross-sectional shape that bulges upward and rearward, and faces the cleaning roller 50 via the fixation belt 28 at the cleaning nip portion NP2. The non-contact surface 52NTS2 has a flat shape from one end side to the other in the longitudinal direction, and faces the bent portion 30B of the fixation frame 30 with a gap therebetween.

The vertical plate 52NV is bent at approximately 45 degrees and extends downward from the lower end of the inclined plate 52NT. The vertical plate 52NV has a planar rear surface 52NVS formed on the front side thereof, which is parallel to the wall plate outer surface 30WS of the fixation frame 30. The rear surface 52NVS is in contact with the wall plate outer surface 30S without any gaps. The rear surfaces 52NVS of the vertical plate is parallel to the upper plate perpendicular direction D1.

In this manner, the opposing member 52 abuts the horizontal plate lower surface 52NHS and the vertical plate rear surface 52NVS against the fixation frame 30. The flat portion width WF (FIG. 9), which is the width in the longitudinal direction (i.e., the left-right direction) of the horizontal plate lower surface 52NHS and the vertical plate rear surface 52NVS, is greater than the paper width WP described above.

To the contrary, the fixation frame 30 and the opposing member 52 are separated from each other at the bent portion 30B between the horizontal plate lower surface 52NHS and the vertical plate rear surface 52NVS. In other words, the fixation frame 30 and the opposing member 52 form a gap at the bent portion 30B between the horizontal plate lower surface 52NHS and the vertical plate rear surface 52NVS. Further, a straight line L1 extending in the direction parallel to the cleaning roller biasing direction Dp from the rotation axis of the cleaning roller 50 intersects the bent portion 30B, which is the region where the fixation frame 30 and the opposing member 52 are separated from each other.

### 1-3-13-3. Configuration of Slit

Five slits 52S are formed at the connection portion between the support portion 52H and the opposing portion 52N. Each of the slits 52S penetrates from the upper surface to the lower surface of the support portion 52H which extends in the left-right direction. Therefore, the cross-sectional area of the connection portion between the support portion 52H and the opposing portion 52N, as viewed in a vertical section extending in the left-right direction (which may be referred to as a contact cross-sectional area), is smaller than that in a configuration where no slits 52S are provided.

### 1-3-14. Crown Shape of Components

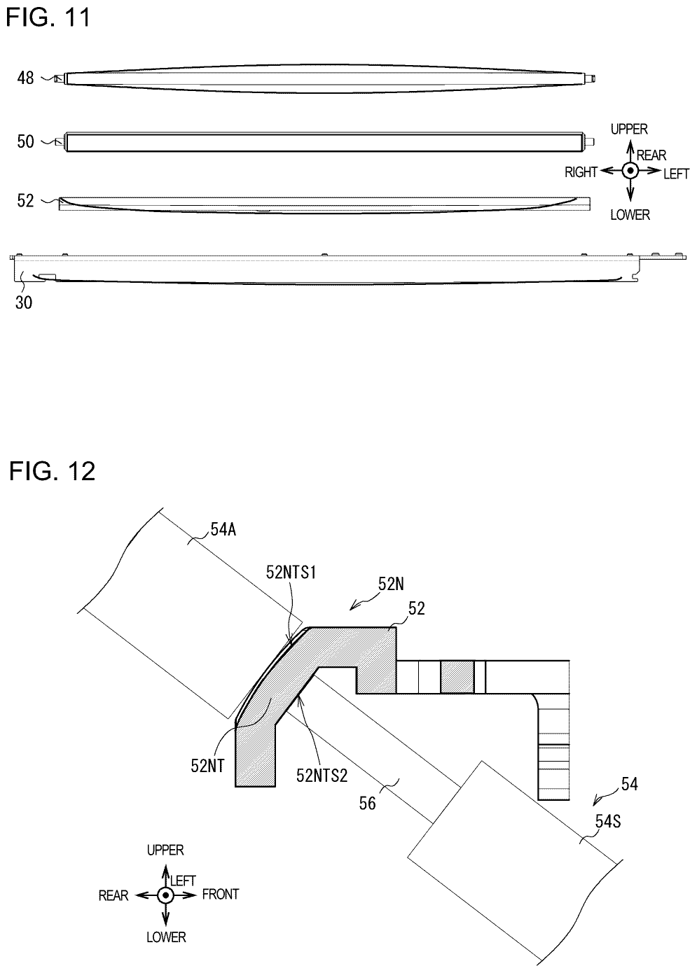

FIG. 11 schematically illustrates, by thick lines, crown shapes of components involved in the cleaning operation. Here, the crown shape originally refers to a shape in which the overall outer shape of a cylindrical member is curved such that the diameter of the longitudinal center portion is larger than the diameter of both end portions, or a shape in which the overall outer shape of a cylindrical member is curved so that the diameter of the longitudinal center portion is smaller than the diameter of both end portions. However, in an embodiment described above, the crown shape is not limited to a cylindrical member, but also refers to a shape in which a portion (e.g., a lower end) of a member is curved as a whole so that the longitudinal center of the portion protrudes downward further than both longitudinal end portions. In an embodiment, the opposing member 52, the cleaning roller 50 and the refreshing roller 48 are arranged in a straight line extending approximately 45 degrees toward the upper rear side relative to the fixation frame 30. However, for the sake of convenience, FIG. 11 illustrates the manner in which forces are applied in the vertical direction and the crown shapes are described, particularly with the opposing member 52 and the fixation frame 30.

Both left and right end portions of the fixation frame 30 are pressed downward toward the pressure roller 29 by the main levers 38L and 38R. For this reason, the lower end of the wall plate 30W of the fixation frame 30 is formed in a downwardly convex crown shape, in which the lower end of the wall plate 30W is curved as a whole such that the central portion in the left-right direction of the lower end protrudes downward. This shape compensates for pressure drop in the central portion, which is prone to losing pressure, to make the pressure distribution uniform across the left-right direction.

When nipping occurs at the fixation nip portion NP1, the downwardly convex crown shape on the lower side of the fixation frame 30 becomes straight. As a result, the upper side of the fixation frame 30, which comes into contact with the opposing member 52, becomes an upwardly convex crown shape, in which the upper side is curved as a whole so that the central portion in the left-right direction of the upper side protrudes upward. Therefore, when nipping occurs at the fixation nip portion NP1, the opposing member 52 receives a force from the fixation frame 30 that causes the upper side of the opposing member 52 to curve as a whole so that the central portion in the left-right direction of the upper side protrudes upward. To accommodate the upward protrusion at the central portion of the upper side of the fixation frame 30, the thickness of the central portion of the nip surface 52NTS1 of the opposing member 52 in the left-right direction is reduced, so that the opposing member 52 has a concave crown-shaped top, with the central portion in the left-right direction being concave downward.

The cleaning roller 50 is sandwiched between the opposing member 52 and the refreshing roller 48, and has a straight shape because if the cleaning roller 50 had a crown shape, the pressure of either the opposing member 52 or the refreshing roller 48 would be reduced or lost. The refreshing roller 48 is pressed toward the cleaning roller 50 at its left and right end portions by the sub-levers 42L and 42R. For this reason, the refreshing roller 48 is formed in a crown shape that is convex in the center portion and curved overall such that the center portion in the left-right direction bulges outward. This configuration compensates for the pressure drop that tends to occur in the center portion in the left-right direction, thereby making the pressure distribution uniform across the left-right direction.

### 1-3-15. Crown Shape Measurement Method

As illustrated in FIG. 12, the crown shape of the opposing member 52 is measured by sandwiching the inclined plate 52NT of the opposing portion 52N between the spindle 54S and the anvil 54A of the micrometer 54, and measuring the thickness of the inclined plate 52NT at predetermined locations along the longitudinal direction. The crown amount is determined based on these thickness measurements. The thickness of the inclined plate 52NT is the thickness from the nip surface 52NTS1 to the non-contact surface 52NTS2.

Here, the non-contact surface 52NTS2 has a flat shape without any projections or recesses from one end side to the other end in the longitudinal direction. This allows the crown amount of the opposing member 52 to be measured without being affected by warping in the longitudinal direction of the opposing member 52. As a result, the distribution of nip pressure across the longitudinal direction of the cleaning nip portion NP2 can be easily managed during mass production of the image formation apparatus 1.

Note that, as illustrated in FIG. 12, the length from the upper end to the lower end of the non-contact surface 52NTS2 is too narrow for the spindle 54S of the micrometer 54 to be inserted. Therefore, a narrow block gauge 56 is sandwiched between the non-contact surface 52NTS2 and the spindle 54S.

### 1-4. Cleaning Operation in Fixation Device

In such a configuration described above, when the print medium P carrying unfixed toner passes through the fixation nip portion NP1 during the printing operation of the image formation apparatus 1, the unfixed toner is fixed to the print medium P at the fixation nip portion NP1. However, a portion of the unfixed toner, particularly at the left and right edge portions of the print medium P, may adhere to the fixation belt 28. If the cleaning roller 50 were not provided, some of the unfixed toner adhered to the fixation belt 28 would adhere to the next print medium P when it passes through the fixation nip portion NP1, thereby causing stains on the next print medium P.

On the other hand, in the configuration where the cleaning roller 50 is provided, as in the image formation apparatus 1, when the fixation belt 28 passes through the cleaning nip portion NP2, unfixed toner adheres to the cleaning roller 50 from the fixation belt 28 and is thereby removed from the fixation belt 28 (this process hereinafter also referred to as a cleaning action or a cleaning operation). When the toner that is adhered to the cleaning roller 50 from the fixation belt 28 passes the nip portion between the cleaning roller 50 and the refreshing roller 48, the toner is removed from the cleaning roller 50 to the refreshing roller 48, thereby keeping the surface of the cleaning roller 50 clean. Incidentally, the toner on the refreshing roller 48 remains uncollected until the end of the life of the fixation device 8.

However, this cleaning action is limited in an area or areas in the longitudinal direction where a certain level or more of nip pressure is applied between the cleaning roller 50 and the fixation belt 28. Therefore, if the nip pressure falls below a certain level (which may be referred to as pressure loss or pressure drop) for various factors, such as the cleaning roller 50 having an uneven shape or being warped in the axial direction, the cleaning action would not function properly in the area(s) where the pressure loss occurs. As a result, unfixed toner would remain on the fixation belt 28 and adhere to the next print medium P, thereby causing contamination of the print medium P.

### 1-5. Effects and the Likes

In the image formation apparatus 1 having the configuration described above, the opposing portion 52N of the opposing member 52, which is arranged in the vicinity of the upper rear side of the bent portion 30B of the fixation frame 30 provided inside the fixation belt 28, is opposed to the cleaning roller 50, which is provided outside the fixation belt 28, and in the nipped state of the cleaning nip portion NP2, the cleaning roller 50 is biased in the cleaning roller biasing direction Dp such that the opposing portion 52N receives the load from the cleaning roller 50. Specifically, relative to the bent portion 30B of the fixation frame 30, the center axis of the cleaning roller 50 is located within a range between a direction extending upward from the upper plate 30U in the upper plate perpendicular direction D1 and a direction extending rearward from the wall plate 30W in the wall plate perpendicular direction D2.

Therefore, the force that the cleaning roller 50 applies to the opposing portion 52N (i.e., the opposing member 52) in the cleaning nip portion NP2 toward the cleaning roller biasing direction Dp (the front-rear direction), includes a force component that acts downward toward the upper plate perpendicular direction D1 and a force component that acts forward toward the wall plate perpendicular direction D2.

Furthermore, the image formation apparatus 1 is configured such that the fixation frame 30 abuts against the lower surface 52NHS of the horizontal plate serving as a first surface of the opposing member 52 and against the rear surface 52NVS of the vertical plate serving as a second surface of the opposing member, while the fixation frame 30 is spaced from the opposing member 52 at the bent portion 30B located between the first surface (the lower surface 52NHS of the horizontal plate) and the second surface (the rear surface 52NVS of the vertical plate).

Here, it is also conceivable that the opposing member 52 is fixed to the fixation frame 30 by fastening (i.e., screwing) with screws, so that the opposing member 52 does not move relative to the fixation frame 30 in any direction, including the front-to-back, left-to-right, and vertical directions. In this case, however, the position of the opposing member 52 relative to the fixation frame 30 in the cleaning roller contact/separation direction Dc is fixed, and the opposing member 52 cannot move relative to the fixation frame 30 in the cleaning roller contact/separation direction Dc.

As a result, the nip pressure increases locally only at the points that are screwed in the longitudinal direction within the cleaning nip portion NP2, causing singular points in the nip pressure distribution along the longitudinal direction. This may prevent the nip pressure from changing smoothly from one end side to the other in the longitudinal direction. In that case, the image formation apparatus 1 would not be able to use the cleaning roller 50 to collect the toner on the fixation belt 28 from one end side to the other in the longitudinal direction as intended.

To the contrary, the image formation apparatus 1 is configured such that, in the non-nip state, the opposing member 52 can wobble relative to the fixation frame 30 in the upper plate perpendicular direction D1 due to the engagement portion 52HF2 being inserted into the engagement hole 30UA1 of the fixation frame 30, and the opposing member 52 can wobble relative to the fixation frame 30 in the wall plate perpendicular direction D2 but is restricted from moving in the longitudinal direction due to the positioning hole 52BA being fitted into the protrusion 30P of the fixation frame 30. Therefore, the image formation apparatus 1 is configured such that, in the non-nip state, the opposing member 52 is movably attached to the fixation frame 30. Therefore, when the cleaning nip portion NP2 is in the non-nip state, the opposing member 52 is positioned relative to the fixation frame 30 in the longitudinal direction, but is not positioned and can move in any other directions, including the upper plate perpendicular direction D1 and the wall plate perpendicular direction D2, which are the directions in which the opposing member receives load from the cleaning roller 50. This allows the opposing member 52 to move in the cleaning roller contact/separation direction Dc relative to the fixation frame 30 when the cleaning nip portion NP2 is in the non-nipped state.

According to the image formation apparatus 1, when the cleaning nip portion NP2 is in the nipped state, the cleaning roller 50 is biased toward the opposing portion 52N in the cleaning roller biasing direction Dp so as to press the opposing member 52 against the fixation frame 30 such that the horizontal plate lower surface 52NHS abuts the fixation frame upper surface 30UUS and the vertical plate rear surface 52NVS abuts the fixation frame wall plate outer surface 30WS, thereby positioning the opposing member 52 relative to the fixation frame 30 in the upper plate perpendicular direction D1 and the wall plate perpendicular direction D2 (i.e., the cleaning roller contact/separation direction Dc).

In this manner, the image formation apparatus 1 is configured such that the opposing member 52 is movable in the cleaning roller contact/separation direction Dc with respect to the fixation frame 30 when the cleaning nip portion NP2 is in the non-nip state. Therefore, the image formation apparatus 1 fixes the position of the opposing member 52 in the longitudinal direction relative to the fixation frame 30, while allowing the opposing member 52 to remain movable relative to the fixation frame 30 in the cleaning roller contact/separation direction Dc, which is a direction other than the longitudinal direction. Accordingly, even if a difference in thermal expansion coefficient arises between the opposing member 52, which is made of resin, and the fixation frame 30, which is made of galvanized steel plate, the opposing member 52 can move in the cleaning roller contact/separation direction Dc relative to the fixation frame 30, thereby preventing physical interference between the opposing member 52 and the fixation frame 30. Therefore, the image formation apparatus 1 can prevent the occurrence of singular points in the pressure distribution in the longitudinal direction within the cleaning nip portion NP2, and can suppress deformation of the opposing member 52 and damage such as cracking caused by differences in thermal expansion coefficients. This allows the image formation apparatus 1 to smoothly change the nip pressure in the cleaning nip portion NP2 from one end side to the other in the longitudinal direction, thereby preventing the occurrence of singular points in the nip pressure distribution in the longitudinal direction. Thus, the image formation apparatus 1 can achieve a smooth nip pressure distribution without any singular points from one end side to the other in the longitudinal direction, allowing the cleaning roller 50 to collect toner on the fixation belt 28 from the one end side to the other in the longitudinal direction as intended.

Furthermore, the image formation apparatus 1 is configured to attach the opposing member 52 to the fixation frame 30 such that the opposing member 52 can move relative to the fixation frame 30 in directions other than the longitudinal direction. Accordingly, when the cleaning nip portion NP2 is in the non-nip state, the opposing member 52 is not positioned in any direction other than the longitudinal direction relative to the fixation frame 30. However, the range in which the opposing member 52 can move relative to the fixation frame 30 is only within the range in which the engagement portion 52HF2 can wobble in the upper plate perpendicular direction D1, and only within the range in which the positioning hole 52BA can wobble relative to the protrusion 30P in the wall plate perpendicular direction D2.

Therefore, the image formation apparatus 1 can prevent the opposing member 52 from coming off the fixation frame 30 during a release operation to change the cleaning nip portion NP2 from the nipped state to the non-nipped state, or due to impacts during transportation of the image formation apparatus 1. Furthermore, according to the image formation apparatus 1, when the cleaning nip portion NP2 is in the nipped state, the cleaning roller 50 is pressed against the nip surface 52NTS1, so that the opposing member 52 is returned to its appropriate position relative to the fixation frame 30.

Furthermore, in the image formation apparatus 1, the opposing member 52 is positioned in the longitudinal direction relative to the fixation frame 30 solely by the positioning hole 52BA and the protrusion 30P, which are provided at a single location in the longitudinal direction. Therefore, the image formation apparatus 1 can suppress deformation or cracking of the opposing member 52 caused by differences in thermal expansion coefficient between the opposing member 52 and the fixation frame 30, compared to a configuration in which the opposing member 52 is positioned in the longitudinal direction relative to the fixation frame 30 at multiple locations in the longitudinal direction.

Furthermore, in the image formation apparatus 1, compared to a configuration in which the opposing member 52 is fixed to the fixation frame 30 by fastening with screws (i.e., screwing), loosening of the screws due to thermal expansion and contraction can be prevented, thereby extending the life of the image formation apparatus 1.

Furthermore, the image formation apparatus 1 is configured such that the fixation frame 30 is abutted against the horizontal plate lower surface 52NHS and the vertical plate rear surface 52NVS of the opposing member 52, and is spaced apart from the opposing member 52 at the bent portion 30B located between the horizontal plate lower surface 52NHS and the vertical plate rear surface 52NVS. In addition, the image formation apparatus 1 is configured such that a straight line L1 extending from the rotation axis of the cleaning roller 50 in the cleaning roller contact/separation direction Dc passes through (i.e., intersects) the bent portion 30B, which is the point where the fixation frame 30 and the opposing member 52 are separated from each other. Therefore, even if the opposing portion 52N receives a load from the cleaning roller 50 at the nip surface 52NTS1, the image formation apparatus 1 can maintain the non-contact surface 52NTS2 on the back side of the nip surface 52NTS1 in a non-contact state with the bent portion 30B of the fixation frame 30, while bringing the horizontal plate lower surface 52NHS and the vertical plate rear surface 52NVS, which are located on either side of the bent portion 30B, into contact with the fixation frame 30. This enables the image formation apparatus 1 to eliminate the influence of the bent portion 30B on the distribution of the nip pressure in the longitudinal direction in the cleaning nip portion NP2.

Furthermore, the image formation apparatus 1 has the flat portion width WF, in the longitudinal direction, of the upper surface 30UUS, the wall plate outer surface 30WS, the horizontal plate lower surface 52NHS and the vertical plate rear surfaces 52NVS (FIG. 9), over a range wider than the paper width WP. These surfaces are formed to have a flat shape without any irregularities. This allows the image formation apparatus 1 to smoothly change the nip pressure in the cleaning nip portion NP2 from one end side to the other in the longitudinal direction, thereby preventing the occurrence of singular points in the nip pressure distribution in the longitudinal direction.

Furthermore, the image formation apparatus 1 is configured such that the opposing member 52 includes the support portion 52H where the opposing member 52 is supported by the fixation frame 30, and the opposing portion 52N where the opposing member 52 faces the cleaning roller 50, and further includes the slits 52S provided between the support portion 52H and the opposing portion 52N, extending in the left-right direction and penetrating from the upper surface to the lower surface of the support portion 52H. In this way, the image formation apparatus 1 includes a portion of the opposing member 52 that functions to be supported by the fixation frame 30, a portion of the opposing member 52 that functions to face the cleaning roller 50, and a connection portion between the support portion 52H and the opposing portion 52N, in which the slits 52S are provided to reduce the cross-sectional area thereof.

For this reason, in the image formation apparatus 1, although the opposing portion 52N of the opposing member 52 is elongated in the longitudinal direction and has the concave crown shape with the thickness biased relative to the center axis, and thus is prone to longitudinal warping during molding and shrinkage, the force required to correct such warping due to the load when the cleaning roller 50 is nipped can be reduced. As a result, the impact of the warping of the opposing portion 52N on the longitudinal nip pressure distribution in the cleaning nip portion NP2 can be reduced.

Here, the opposing member 52 is in contact with the fixation frame 30 over a wide area on its lower surface at the support portion 52H, while at the opposing portion 52N, only the horizontal plate lower surface 52NHS and the vertical plate rear surface 52NVS of the opposing member 52 are in contact with the fixation frame 30, avoiding the bent portion 30B. In view of this, the image formation apparatus 1 is configured such that the sectional area of the connection portion between the support portion 52H and the opposing portion 52N is reduced by providing the slits 52S. As a result, the image formation apparatus 1 makes it difficult for heat transferred from the fixation belt 28 to the opposing portion 52N to be further transferred to the fixation frame 30 (i.e., difficult for the heat to escape), thereby maintaining the advantage of the fixation belt method, namely quick heating.

Furthermore, the image formation apparatus 1 is configured such that the nip surface 52NTS1 of the opposing member 52 is aligned with the outer circumferential surfaces of the belt support portions 40H of the flanges 40L and 40R. Therefore, the image formation apparatus 1 can minimize deformation of the fixation belt 28 during operation, thereby maintaining its durability. This may be particularly preferable when both left and right end portions of the nip surface 52NTS1, which are close to the outer circumferential surfaces of the belt support portions 40H, are flush with the outer circumferential surfaces of the belt support portions 40H. Although the nip surface 52NTS1 has the longitudinal central portion slightly recessed compared to the longitudinal end portions due to its concave crown shape, it is sufficient if the shape transitions smoothly from the longitudinal central portion to both longitudinal end portions.

According to the configuration described above, the fixation device 8 of the image formation apparatus 1 includes: the fixation belt 28 extending in the left-right direction (longitudinal direction) as a first direction; the cleaning roller 50 extending in the left-right direction and being in contact with the fixation belt 28 to perform cleaning the fixation belt 28, the opposing member 52 extending in the left-right direction and facing the cleaning roller 50 across the fixation belt 28 in the cleaning roller contact/separation direction Dc as a second direction, forming the cleaning nip portion NP2 with the cleaning roller 50; and the fixation frame 30 supporting the opposing member 52, wherein, when the opposing member 52 and the fixation frame 30 are removed from the fixation device 8, the opposing member 52 is supported by the fixation frame 30 such that the opposing member 52 is restricted from moving in the left-right direction, while remaining movable in the cleaning roller contact/separation direction Dc relative to the fixation frame 30.

As a result, the fixation device 8 fixes the position of the opposing member 52 in the longitudinal direction relative to the fixation frame 30 while allowing the opposing member 52 to move relative to the fixation frame 30 in the cleaning roller contact/separation direction Dc, which is a direction other than the longitudinal direction, This configuration accommodates any difference in thermal expansion coefficient between the opposing member 52 and the fixation frame 30, thereby preventing the occurrence of singularities in the longitudinal pressure distribution in the cleaning nip portion NP2.

### 2. Second Embodiment

### 2-1. Configuration of Image Formation Apparatus

As illustrated in FIG. 1, an image formation apparatus 101 according to a second embodiment is configured the same as or similar to the image formation apparatus according to a first embodiment except that the image formation apparatus 101 includes a fixation device 108 instead of the fixation device 8.

### 2-2. Configuration of Fixation Device

As illustrated in FIG. 2, the fixation device 108 according to a second embodiment differs from the fixation device 8 according to a first embodiment in that the fixation device 108 includes a fixation frame 130 instead of the fixation frame 30 and an opposing member 152 instead of the opposing member 52, but is otherwise configured in the same manner.

### 2-2-1. Configuration of Fixation Frame

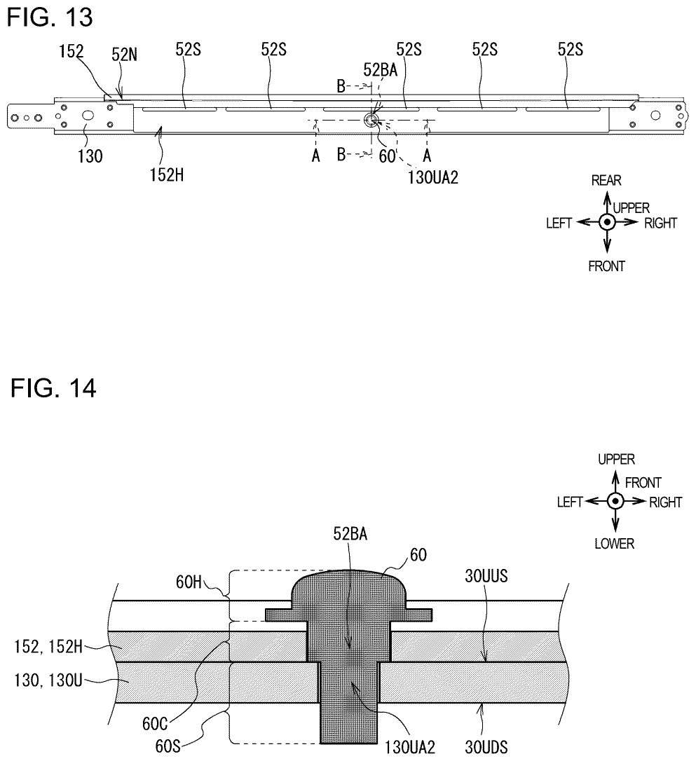

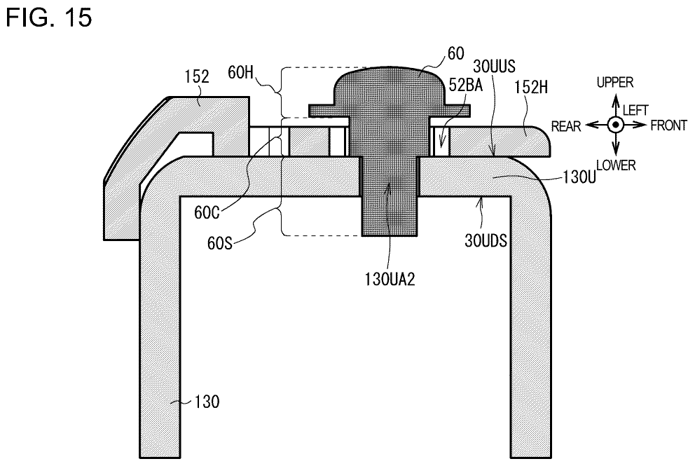

As illustrated in FIGS. 13, 14 and 15, in which the same reference numerals are used for components corresponding to those in FIG. 5, a fixation frame 130 according to a second embodiment differs from the fixation frame 30 according to a first embodiment in that the fixation frame 130 includes a fixation frame upper plate 130U instead of the fixation frame upper plate 30U, but is otherwise configured in the same manner. The fixation frame upper plate 130U according to a second embodiment differs from the fixation frame upper plate 30U according to a first embodiment in that the embossment 30P and the engagement hole 30UA1 are omitted and a positioning hole 130UA2 is added, but is otherwise configured in the same manner.

The positioning hole 130UA2 is formed at the approximate center portion in the left-right direction of the fixation frame upper plate 130U such that the center of the positioning hole 130UA2 is aligned with the center of the positioning hole 52BA of the opposing member 152 in the front-rear direction. This positioning hole 130UA2 is a cylindrical through hole that penetrates from the upper surface 30UUS to the lower surface 30UDS, has a diameter smaller than the front-rear length of the positioning hole 52BA and also smaller than the diameter of the cylindrical portion 60C of the shoulder screw 60.

### 2-2-2. Configuration of Opposing Member

The opposing member 152 according to a second embodiment differs from the opposing member 52 according to a first embodiment in that the opposing member 152 includes a support portion 152H instead of the support portion 52H, but is otherwise configured in the same manner. The support portion 152H according to a second embodiment differs from the support portion 52H according to a first embodiment in that the hook portion 52HF and the flexible portion 52B are omitted, but otherwise the support portion 152H is configured in the same manner.

The support portion 152H includes a positioning hole 52BA, which is configured in the same manner as in a first embodiment, formed at approximately the center in the left-right direction of the support portion 152H. The positioning hole 52BA is an elongate hole (long hole) that extends linearly along the short side direction (the front-rear direction) of the opposing member 152 and penetrates from the upper surface to the lower surface of the support portion 152H.

The opposing member 152 is fixed to the fixation frame 130 by inserting the shoulder screw 60 through the positioning hole 52BA of the opposing member 152 and the positioning hole 130UA2 of the fixation frame upper plate 130U, and fastening the shoulder screw 60. The shoulder screw 60 includes, in order from the lower end (i.e., a distal end or a tip) toward the upper end thereof, a threaded portion 60S, a cylindrical portion 60C, and a head portion 60H. The screw portion 60S has a thread cut on its outer circumferential surface and is fastened to the positioning hole 130UA2 of the fixation frame upper plate 130U.

The cylindrical portion 60C is fitted into the positioning hole 52BA. The cylindrical portion 60C has a cylindrical column shape with a diameter greater than the nominal diameter of the threaded portion 60S. The outer diameter of the cylindrical portion 60C is approximately the same as the width in the left-right direction of the positioning hole 52BA of the opposing member 152, and is shorter than the length in the front-rear direction of the positioning hole 52BA. Therefore, when the cylindrical portion 60C of the shoulder screw 60 is fitted into the positioning hole 52BA, no gap is formed between the left end of the cylindrical portion 60C and the left end of the positioning hole 52BA, and between the right end of the cylindrical portion 60C and the right end of the positioning hole 52BA. To the contrary, when the cylindrical portion 60C of the fixation frame 130 fits into, for example, the center portion in the front-rear direction of the positioning hole 52BA, a gap is formed between the front end of the cylindrical portion 60C and the front end of the positioning hole 52BA, and between the rear end of the cylindrical portion 60C and the rear end of the positioning hole 52BA. Therefore, the cylindrical portion 60C of the fixation frame 130 is fitted into the positioning hole 52BA so as to be immovable in the left-right direction but movable in the front-rear direction. As a result, the opposing member 152 is fixed to the fixation frame 130 in a state where the opposing member 152 is positioned so as not to move in the longitudinal direction relative to the fixation frame 130 while being allowed to wobble to some extent in the shorter side direction (i.e., the front-rear direction) within the positioning hole 52BA.

The head 60H has an outer diameter that is greater than the left-right width and front-rear length of the positioning hole 52BA, and includes a tool hole on the top surface thereof for inserting a screwdriver or the like. To the contrary, the cylindrical portion 60C has the diameter greater than the positioning hole 130UA2 of the fixation flame, and has the vertical length greater than the vertical length (i.e., thickness) of the support portion 152H. Therefore, when the shoulder screw 60 is fastened into the positioning hole 130UA2 of the fixation flame, the lower surface of the cylindrical portion 60C abuts against the upper surface 30UUS of the fixation frame, thereby restricting the downward movement of the shoulder screw 60, with a certain amount of gap being formed between the head portion 60H of the shoulder screw 60 and the upper surface of the support portion 152H. For this reason, the opposing member 152 is attached to the fixation frame 130 in such a manner that the opposing member 152 can wobble to a certain extent in the vertical direction, but not to the extent that it would become detached due to impacts during transportation or when the cleaning nip portion NP2 is in a non-nip state.

### 2-3. Effects and the Like

In this way, the fixation device 108 is configured such that, in the non-nip state of the cleaning nip portion NP2, the opposing member 152 is fixed to the fixation frame 130 in a manner that allows the opposing member 52 to wobble to a certain extent in the front-rear and vertical directions, by inserting the shoulder screw 60 into the positioning hole 52BA of the opposing member 152 and the positioning hole 130UA2 of the fixation frame upper plate 130U, and fastening the opposing member 152 to the fixation frame upper plate 130U. Therefore, the fixation device 108 according to a second embodiment can be assembled without a portion of the opposing member 52 having to bend, unlike the flexible portion 52B of the fixation device 8 according to a first embodiment. This allows the fixation device 108 to use, for the opposing member 152, even a material that has low toughness and is unsuitable for bending during assembly of the fixation device 108. This may be particularly useful when a highly heat-resistant resin material is used for the opposing member 152, as such material tend to be hard and prone to cracking. Furthermore, even if there is no space to allow the opposing member 152 to bend upward during assembly of the fixation device 108, the opposing member 152 can be fixed to the fixation frame 130.

In other respects, the image formation apparatus 101 according to a second embodiment provides the effects same as or similar to that of the image formation apparatus 1 according to a first embodiment.

### 3. Other Embodiments

In a first embodiment described above, a case has been described in which the image formation apparatus 1 is configured such that the opposing member 52 movably attached to the fixation frame 30 in the upper plate perpendicular direction D1 and the wall plate perpendicular direction D2, and, in the nip state of the cleaning nip portion NP2, the cleaning roller 50 presses the opposing member 52 in the cleaning roller biasing direction Dp thereby positioning the opposing member 52 relative to the fixation frame 30 in the directions D1 and D2. The invention is not limited to thereto. For example, in the nip state of the cleaning nip portion NP2, the image formation apparatus 1 may position the opposing member 52 relative to the fixation frame 30 in only one of the upper plate perpendicular direction D1 or the wall plate perpendicular direction D2 using the cleaning roller 50, while positioning the opposing member 52 in the other direction using a member other than the cleaning roller 50. The same is true for a second embodiment described above.

In addition, in a first embodiment described above, a case has been described in which the image formation apparatus 1 positions the opposing member 52 in the longitudinal direction relative to the fixation frame 30 by fitting the positioning hole 52BA, which is provided approximately in the center of the longitudinal direction of the opposing member 52, to the protrusion 30P of the fixation frame 30. The invention is not limited thereto. For example, the image formation apparatus 1 may also position the opposing member 52 in the longitudinal direction relative to the fixation frame 30 by fitting a positioning hole 52BA provided at another location in the longitudinal direction of the opposing member 52 to the protrusion 30P provided in the fixation frame 30 at a position corresponding to the positioning hole 52BA. The same is true for a second embodiment described above.

Furthermore, in one or more embodiments described above, a case has been described in which the invention is applied to the image formation apparatus 1 or 101 in which the cylindrical cleaning roller 50 is brought into contact with the outer circumferential surface of the fixation belt 28 to collect the toner on the fixation belt 28. The invention is not limited thereto. For example, the invention may be applied to an image formation apparatus in which a cleaning belt, which is an endless belt stretched around rollers provided on the inside, is brought into contact with the outer circumferential surface of the fixation belt to collect toner on the fixation belt.

Furthermore, in a first embodiment described above, the image formation apparatus 1 includes the slits 52S extend along the left-right direction. The invention is not limited thereto. For example, the image formation apparatus 1 may include slits 52S that extend in a direction inclined with respect to the left-right direction. In short, in the image formation apparatus 1, it may be sufficient for the slits 52S extending in a direction that includes the left-right direction component. The same is true for a second embodiment described above.

Furthermore, in a first embodiment described above, the image formation apparatus 1 may have various other configurations in which the opposing member 52 is attached to the fixation frame 30 such that the opposing member 52 is immovable with respect to the fixation frame 30 in the longitudinal direction, while being movable in the upper plate perpendicular direction D1 and the wall plate perpendicular direction D2. The same is true for a second embodiment described above.

Furthermore, in a second embodiment described above, a case has been described in which the image formation apparatus 101 is configured such that the opposing member 152 is attached to the fixation frame 130 by the shoulder screw 60 such that the opposing member 152 is movable with respect to the fixation frame 130 in the upper plate perpendicular direction D1 and the wall plate perpendicular direction D2. The invention is not limited thereto. For example, the image formation apparatus 101 may use a normal screw, which does not have the cylindrical portion 60C, and a spacer in place of the cylindrical portion 60C, or may provide a step that protrudes upward from the fixation frame upper surface 30UUS around the cylindrical portion 60C, thereby the opposing member 152 is fixed to the fixation frame 130 so that the opposing member 152 is movable in the upper plate perpendicular direction D1 and the wall plate perpendicular direction D2.

Furthermore, in one or more embodiments described above, a case has been described in which the invention is applied to the image formation apparatus 1 or 101 of a so-called direct transfer type in which toner images are directly transferred from the photosensitive drums 20 of the image formation units 14 to the print medium P. The invention is not limited thereto. For example, the invention may be applied to an image formation apparatus of a so-called intermediate transfer type (or secondary transfer type), in which toner images of respective colors are sequentially transferred from the photosensitive drums 20 of the image formation units 14 to an intermediate transfer belt in a superimposed manner, and then transferred from the intermediate transfer belt to a print medium P.

Furthermore, in one or more embodiments described above, the invention is applied to the image formation apparatus 1 or 101 that uses a developer of a one-component development type. However, the invention is not limited thereto. For example, the invention may be applied to an image formation apparatus that uses a developer of a two-component development type, in which an appropriate amount of charge is imparted to the toner by mixing it with a carrier, utilizing friction between the carrier and the toner.

Furthermore, in one or more embodiments described above, a case has been described in which the invention is applied to the image formation apparatus 1 or 101 including the four image formation units 14 and forming color images using the toner of four colors. However, the invention is not limited thereto. For example, the invention may be applied to an image formation apparatus that includes at most three or at least five image formation units 14 and forms images using toner in a predetermined number of colors.

Furthermore, in an embodiment described above, a case has been described where the invention is applied to the image formation apparatus 1 or 101, which is a single function printer. However, the invention is not limited thereto. For example, the invention may be applied to an image formation apparatus having multiple functions such as a multi-function peripheral having a photocopier function and a facsimile device function. The invention may be also applied to various electronic devices that form an image(s) on print medium P such as paper using a developer(s) by an electrophotographic method.

Furthermore, the invention is not limited to one or more embodiments and modifications described above. That is, the application range of the invention covers embodiments obtained by arbitrarily combining some of or all of one or more embodiments and modifications described above. The scope of the invention also extends to an embodiment in which a part of the configuration in any one of one or more embodiments and modifications described above that is extracted is replaced or diverted with a part of the configuration of any one of one or more embodiments and modifications, or an embodiment in which the extracted part is added to any of one or more embodiments and modifications described above.

Furthermore, in a first embodiment described above, a case has been described in which the fixation device 8 is configured by the fixation belt 28 as a belt member, the cleaning roller 50 as a cleaning member, the opposing member 52 as an opposing member, and the fixation frame 30 as a support member. The invention is not limited thereto. For example, the fixation device may be configured by a belt member, a cleaning member, an opposing member, and a support member having various other configurations.

The invention can be used in cases where an electrophotographic image formation apparatus is used to print images on a medium.

1. A fixation device comprising:
a belt member extending in a first direction;
a cleaning member extending in the first direction and being in contact with the belt member to clean the belt member;
an opposing member extending in the first direction, and opposed to the cleaning member in a second direction across the belt member, to form a nip portion with the cleaning member; and
a support member supporting the opposing member, wherein
the opposing member is configured, when the opposing member and the support member are removed from the fixation device, to be supported by the support member such that the opposing member is restricted from moving in the first direction and is movable in the second direction relative to the support member.

2. The fixation device according to claim 1, wherein
the opposing member is configured, when the opposing member and the support member are attached to the fixation device, to be pressed by the cleaning member at the nip portion so as to be positioned in the second direction relative to the support member.

3. The fixation device according to claim 1, wherein
the support member is in contact with a first surface and a second surface of the opposing member and is spaced apart from the opposing member in an area between the first surface and the second surface, and
a straight line extending from a rotation axis of the cleaning member along the second direction intersects the area where the support member and the opposing member are spaced apart.

4. The fixation device according to claim 3, wherein
a virtual straight line along the first surface and a virtual straight line along the second surface intersect with each other, and the support member supports the opposing member such that the opposing member is movable in a direction parallel to the first surface and movable in a direction parallel to the second surface.

5. The fixation device according to claim 4, wherein
the opposing member includes: a hook portion that engages with a surface of the support member opposite to a surface of the support member that abuts the first surface of the opposing member with a gap therebetween in the direction parallel to the second surface; and a flexible portion that is bendable in the direction parallel to the second surface, the flexible portion including an elongate hole that extends in a direction parallel to the first surface other than the first direction and in which a protrusion of the support member is movably fitted.

6. The fixation device according to claim 4, wherein
the opposing member includes an elongate hole extending in a direction parallel to the first surface other than the first direction, and
the opposing member is held by the support member, in such a manner that a portion of a screw between a head and a tip of the screw is fitted into the elongate hole of the opposing member so as to be movable in a direction that is parallel to the first surface and intersects with the first direction, with the head of the screw being spaced apart, in the direction parallel to the second surface, from a surface of the opposing member opposite to a surface of the opposing member that abuts against the support member.

7. The fixation device according to claim 1, wherein
the opposing member is restricted at one location in the first direction from moving in the first direction relative to the support member.

8. The fixation device according to claim 1, wherein
the opposing member includes a support portion supported by the support member, an opposing portion opposed to the cleaning member, and a slit extending in the first direction between the support portion and the opposing portion.

9. An image formation apparatus comprising:
the fixation device according to claim 1.
